(19) United States
(12) Patent Application Publication
(10) Pub. No.: US 2014/0373036 A1
(43) Pub. Date: Dec. 18, 2014

(54) HYBRID VIDEO RECOGNITION SYSTEM BASED ON AUDIO AND SUBTITLE DATA

(71) Applicant: TELEFONAKTIEBOLAGET L M ERICSSON (PUBL), Stockholm (SE)

(72) Inventors: Chris Phillips, Hartwell, GA (US); Michael Huber, Sundbyberg (SE); Jennifer Ann Reynolds, Duluth, GA (US); Charles Hammett Dasher, Lawrenceville, GA (US)

(73) Assignee: TELEFONAKTIEBOLAGET L M ERICSSON (PUBL), Stockholm (SE)

(21) Appl. No.: 13/918,397

(22) Filed: Jun. 14, 2013

(51) Int. Cl. H04N 21/422; H04N 21/239; H04N 21/442

(52) U.S. Cl. CPC H04N 21/42203; H04N 21/44222; H04N 21/239
USPC 725/12

(57) ABSTRACT

A system and method where a second screen app on a user device “listens” to audio clues from a video playback unit that is currently playing an audio-visual content. The audio clues include background audio and human speech content. The background audio is converted into Locality Sensitive Hashtag (LSH) values. The human speech content is converted into an array of text data. The LSH values are used by a server to find a ballpark estimate of where in the audio-visual content the captured background audio is from. This ballpark estimate identifies a specific video segment. The server then matches dialog text array with pre-stored subtitle information (for the identified video segment) to provide a more accurate estimate of the current play-through location within that video segment. A timer-based correction provides additional accuracy. The combination of LSH-based and subtitle-based searches provides fast and accurate estimates of an audio-visual program's play-through location.

### TECHNICAL FIELD

The present disclosure generally relates to “second screen” solutions or software applications (“apps”) that often pair with video playing on a separate screen (and thereby inaccessible to a device hosting the second screen application). More particularly, and not by way of limitation, particular embodiments of the present disclosure are directed to a system and method to remotely and automatically detect the audio-visual content being watched—as well as where the viewer is in that content—by analyzing background audio and human speech content associated with the audio-visual content.

### BACKGROUND

In today's world of content-sharing among multiple devices, the term “second screen” is used to refer to an additional electronic device (for example, a tablet, a smartphone, a laptop computer, and the like) that allows a user to interact with the content (for example, a television show, a movie, a video game, etc.) being consumed by the user at another (“primary”) device such as a television (TV). The additional device (also sometimes referred to as a “companion device”) is typically more portable as compared to the primary device. Generally, extra data (for example, targeted advertisement) are typically displayed on the portable device synchronized with the content being viewed on the television. The software that facilitates such synchronized delivery of additional data is referred to as a “second screen application” (or “second screen app”) or a “companion app,”

In recent years, more and more people rely on mobile web. As a result, many people use their personal computing devices (for example, a tablet, a smartphone, a laptop, and the like) simultaneously for example, for online chatting, shopping, web surfing, etc.) while watching a TV or playing a video game on another video terminal. The computing devices are typically more “personal” in nature as compared to the “public” displays on a TV in a living room or a common video terminal. Many users also perform search and discovery of content (over the Internet) that is related to what they are watching on TV. For example, if there is a show about a particular US president on a history channel, a user may simultaneously search the web for more information about that president or a particular time-period of that president's presidency. A second screen app can make a user's television viewing more enjoyable if the second screen app were to be aware of what is currently on the TV screen. The second screen app could then offer related news or historical information to the user without requiring the user to search for the relevant content. Similarly, the second screen app could provide additional targeted content—for example, specific online games, products, advertisements, tweets, etc.—all driven by the user's watching of the TV, and without requiring any input or typing from the user of the “second screen” device.

The second screen apps thus track and leverage what a user is currently watching on a relatively “public” terminal (for example, a TV). A synchronized second screen also offers a way to monetize television content, without the need for interruptive television commercials (which are increasingly being skipped by viewers via Video-On-Demand (VOD) or personal Digital Video Recorder (DVR) technologies). For example, a car manufacturer may buy the second screen ads whenever its competitors' car commercials are on the TV. As another example, if a particular food product is being discussed in a cooking show on TV, a second screen app may facilitate display of web browser ads for that food product on the user's portable device(s). Thus, a second screen can be used for controlling and consuming media through synchronization with the “primary” source.

The “public” terminal (for example, a TV) and its displayed content are generally inaccessible to the second screen app through normal means because that terminal is physically different (with its own dedicated audio/video feed—for example, from a cable operator or a satellite dish) from the device hosting the app. Hence, the second screen apps may have to “estimate” what is being viewed on the TV. Some apps perform this estimation by requiring the user to provide the TV's ID and then supplying that ID to a remote server, which then accesses a database of unique hashed metadata (associated with the video signal being fed to the TV) to identify the current content being viewed. Some other second screen applications use the portable device's microphone to wirelessly capture and monitor audio signals from the TV. These apps then look for the standard audio watermarks typically present in the TV signals to synchronize a mobile device to TV's programming.

### SUMMARY

Although presently-available second screen apps are able to “estimate” what is being viewed on a TV (or other public device), such estimation is coarse in nature. For example, identification of two consecutive audio watermarks merely identifies a video segment between these two watermarks; it does not specifically identify the exact play-through location within that video segment. Similarly, a database search of video signal-related hashed metadata also results in identification of an entire video segment (associated with the metadata), and not of a specific play-through instance within that video segment. Such video segments may be of considerable length—for example, 10 seconds.

Existing second screen solutions fail to specifically identify a playing movie (or other audio-visual content) using audio clues. Furthermore, existing solutions also fail to identify with any useful granularity what part of the movie is currently being played.

It is therefore desirable to devise a second screen solution that substantially accurately identifies the play-through location within an audio-visual content currently being played on a different screen (for example, a TV or video monitor) using audio clues. Rather than identifying an entire segment of the audio-visual content, it is also desirable to have such identification with useful granularity so as to enable second screen apps to have a better hold on consumer interests.

The present disclosure offers a solution to the above-mentioned problem (of accurate identification of a play-through location) faced by current second screen apps. Particular embodiments of the present disclosure provides a system where a second screen app “listens” to audio clues (i.e., audio signals coming out of the “primary” device such as a television) using a microphone of the portable user device (which hosts the second screen app). The audio signals from the TV may include background music or audio as well as non-audio human speech content (for example, movie dialogs) occurring in the audio-visual content that is currently being played on the TV. The background audio portion may be converted into respective audio fragments in the form of Locality Sensitive Hashtag (LSH) values. The human speech content may be converted into an array of text data using speech-to-text conversion. In one embodiment, the user device receiving the audio signals may itself perform the generation of LSH values and text array. In another embodiment, a remote server may receive raw audio data from the user device (via a communication network) and then generate the LSH values and text array therefrom. The LSH values may be used by the server to find a ballpark (or “coarse”) estimate of where in the audio-visual content the captured audio clip is from. This ballpark estimate may identify a specific video segment. With this ballpark estimate as the starting point, the server matches dialog text array with pre-stored subtitle information (associated with the identified video segment) to provide a more accurate estimate of the current play-through location within that video segment. Hence, this two-stage analysis of audio clues provides the necessary granularity for meaningful estimation of the current play-through location. In certain embodiments, additional accuracy may be provided by the user device through a timer-based correction of various time delays encountered in the server-based processing of audio clues.

It is observed here that systems exist for detecting which audio stream is playing by searching a library of known audio fragments (or LSH values). Such systems automatically detect things like music, title tune of a TV show, and the like. Similarly, systems exist which translate audio dialogs to text or pair video data with subtitles. However, existing second screen apps fail to integrate an LSH-based search with a text array-based search (using audio clues only) in the manner mentioned in the previous paragraph (and discussed in more detail later below) to generate a more robust estimation of what part of the audio-visual content is currently being played on a video playback system (such as a cable TV).

In one embodiment, the present disclosure is directed to a method of remotely estimating what part of an audio-visual content is currently being played on a video playback system. The estimation is initiated by a user device in the vicinity of the video playback system. The user device includes a microphone and is configured to support provisioning of a service to a user thereof based on an estimated play-through location of the audio-visual content. The method comprises performing the following steps by a remote server in communication with the user device via a communication network: (i) receiving audio data from the user device via the communication network, wherein the audio data electronically represents background audio as well as human speech content occurring in the audio-visual content currently being played; (ii) analyzing the received audio data to generate information about the estimated play-through location indicating what part of the audio-visual content is currently being played on the video playback system; and (iii) sending the estimated play-through location information to the user device via the communication network.

In another embodiment, the present disclosure is directed to a method of remotely estimating what part of an audio-visual content is currently being played on a video playback system, wherein the estimation is initiated by a user device in the vicinity of the video playback system. The user device includes a microphone and is configured to support provisioning of a service to a user thereof based on an estimated play-through location of the audio-visual content. The method comprises performing the following steps by the user device: (i) sending the following to a remote server via a communication network, wherein the user device is in communication with the remote server via the communication network: (a) a plurality of Locality Sensitive Hashtag (LSH) values associated with audio in the audio-visual content currently being played, and (b) an array of text data generated from speech-to-text conversion of human speech content in the audio-visual content currently being played; and (ii) receiving information about the estimated play-through location from the server via the communication network, wherein the estimated play-through location information is generated by the server based on an analysis of the LSH values and the text array, and wherein the estimated play-through location indicates what part of the audio-visual content is currently being played on the video playback system.

In a further embodiment, the present disclosure is directed to a method of offering video-specific targeted content on a user device based on remote estimation of what part of an audio-visual content is currently being played on a video playback system that is physically present in the vicinity of the user device. The method comprises the following steps: (i) configuring the user device to perform the following: (a) capture background audio and human speech content in the currently-played audio-visual content using a microphone of the user device, (b) generate a plurality of LSH values associated with the background audio that accompanies the audio-visual content currently being played, (c) further generate an array of text data from speech-to-text conversion of the human speech content in the audio-visual content currently being played, and (d) send the plurality of LSH values and the text data array to a server in communication with the user device via a communication network; (ii) configuring the server to perform the following: (a) analyze the received LSH values and the text array to generate information about an estimated position indicating what part of the audio-visual content is currently being played on the video playback system, and (b) send the estimated position information to the user device via the communication network; and (iii) further configuring the user device to display the video-specific targeted content to a user thereof based on the estimated position information received from the server.

In another embodiment, the present disclosure is directed to a system for remotely estimating what part of an audio-visual content is currently being played on a video playback device. The system comprises a user device; and a remote server in communication with the user device via a communication network. In the system, the user device is operable in the vicinity of the video playback device and is configured to initiate the remote estimation to support provisioning of a service to a user of the user device based on the estimated play-through location of the audio-visual content. The user device includes a microphone and is further configured to send audio data to the remote server via the communication network, wherein the audio data electronically represents background audio as well as human speech content occurring in the audio-visual content currently being played. In the system, the remote server is configured to perform the following: (i) receive the audio data from the user device, (ii) analyze the received audio data to generate information about an estimated position indicating what part of the audio-visual content is currently being played on the video playback device, and (iii) send the estimated position information to the user device via the communication network.

The present disclosure thus combines multiple video identification techniques—i.e., LSH-based search combined with subtitle search (using text data from speech-to-text conversion of human speech content)—to provide fast (necessary for real time applications) and accurate estimates of an audio-visual program's current play-through location. This approach allows second screen apps to have a better hold on consumer interests. Furthermore, particular embodiments of the present disclosure allow third party second screen apps to provide content (for example, advertisements, trivia, questionnaires, and the like) based on the exact location of the viewer in the movie or other audio-visual program being watched. Using the two-stage position estimation approach of the present disclosure, these second screen apps can also record things like when viewers stopped watching a movie (if not watched all the way through), paused a movie, fast forwarded a scene, re-watched particular scenes, and the like.

### BRIEF DESCRIPTION OF THE DRAWINGS

In the following section, the present disclosure will be described with reference to exemplary embodiments illustrated in the figures, in which:

FIG. 1 is a simplified block diagram of an exemplary embodiment of a video recognition system of the present disclosure;

FIG. 2A is an exemplary flowchart depicting various steps performed by the remote server in FIG. 1 according to one embodiment of the present disclosure;

FIG. 2B is an exemplary flowchart depicting various steps performed by the user device in FIG. 1 according to one embodiment of the present disclosure;

FIG. 3 illustrates exemplary details of the video recognition system generally shown in FIG. 1 according to one embodiment of the present disclosure;

FIG. 4 shows an exemplary flowchart depicting details of various steps performed by a user device as part of the video recognition procedure according to one embodiment of the present disclosure;

FIG. 5 is an exemplary flowchart depicting details of various steps performed by a remote server as part of the video recognition procedure according to one embodiment of the present disclosure;

FIG. 6 provides an exemplary illustration showing how a live video feed may be processed according to one embodiment of the present disclosure to generate respective audio and video segments therefrom; and

FIG. 7 provides an exemplary illustration showing how a VOD (or other non-live or pre-stored) content may be processed according to one embodiment of the present disclosure to generate respective audio and video segments therefrom.

### DETAILED DESCRIPTION

In the following detailed description, numerous specific details are set forth in order to provide a thorough understanding of the present disclosure. However, it will be understood by those skilled in the art that the teachings of the present disclosure may be practiced without these specific details. In other instances, well-known methods, procedures, components and circuits have not been described in detail so as not to obscure the present disclosure. Additionally, it should be understood that although the content and location look-up approach of the present disclosure is described primarily in the context of television programming (for example, through a satellite broadcast network), the disclosure can be implemented for any type of audio-visual content (for example, movies, non-television video programming or shows, and the like) and also by other types of content providers (for example, a cable network operator, a non-cable content provider, a subscription-based video rental service, and the like) as described in more detail later hereinbelow.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (for example, “audio-visual,” “speech-to-text,” and the like) may be occasionally interchangeably used with its non-hyphenated version (for example, “audiovisual,” “speech to text,” and the like), a capitalized entry such as “Broadcast Video,” “Satellite feed,” and the like may be interchangeably used with its non-capitalized version, and plural terms may be indicated with or without an apostrophe (for example, TV's or TVs, UE's or UEs, etc.). Such occasional interchangeable uses shall not be considered inconsistent with each other.

It is noted at the outset that the terms “coupled,” “connected”, “connecting,” “electrically connected,” and the like are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale.

It is observed at the outset that the terms like “video content,” “video,” and “audio-visual content” are used interchangeably herein, and the terms like “movie,” “TV show,” “TV program.” are used as examples of such audio-visual content. The present disclosure is applicable to many different types of audio-visual programs movies or non-movies. Although the discussion below primarily relates to video content delivered through a cable television network operator (or cable TV service provider, including a satellite broadcast network operator) to a cable television subscriber, it is noted here that the teachings of the present disclosure may be applied to delivery of audio-visual content by non-cable service providers as well, regardless of whether such service requires subscription or not. For example, it can be seen from the discussion below that the video content recognition according to the teachings of the present disclosure may be suitably applied to online Digital Video Disk (DVD) movie rental/download services that may offer streaming video/movie rentals on subscription-basis (for example, unlimited video downloads for a fixed monthly fee or a fixed number of movie downloads for a specific charge). Similarly, satellite TV providers, broadcast TV stations, or telephone companies offering television programming over telephone lines or fiber optic cables may suitably offer second screen apps utilizing the video recognition approach of the present disclosure to more conveniently offer targeted content to their second screen “customers” as per the teachings of the present disclosure. Alternatively, a completely unaffiliated third party having access to audio and subtitle databases (discussed below) may offer second screen apps to users (whether through subscription or for free) and generate revenue through targeted advertising. More generally, an entity delivering audio-visual content (which may have been generated by some other entity) to a user's video playback system may be different from the entity offering/supporting second screen apps on a portable user device.

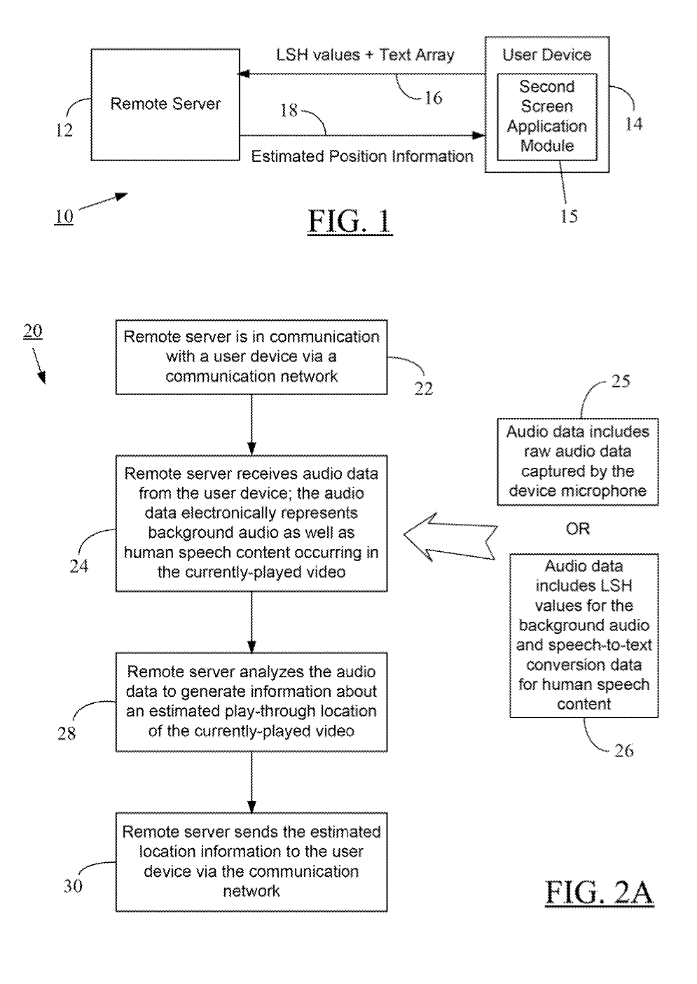

FIG. 1 is a simplified block diagram of an exemplary embodiment of a video recognition system 10 of the present disclosure. A remote server 12 is shown to be in communication with a user device 14 running a second screen application module or software 15 according to one embodiment of the present disclosure. As mentioned earlier, the user device 14 may be a web-enabled smartphone such as a User Equipment (UE) for cellular communication, a laptop, a tablet computer, and the like. The second screen app 15 may allow the user device 14 to capture the audio emanating from a video or audio-visual playback system (for example, a cable TV, a TV connected to a set-top-box (STB). and the like) (not shown in FIG. 1) where an audio-visual content is currently being played. As noted earlier, the audio from the playback system may include background audio as well as human speech content (such as movie dialogs). The device 14 may include a microphone (not shown) to wirelessly capture the audio signals (generally radio frequency (RF) waves containing the background audio and the human speech content) from the playback system. In the embodiment of FIG. 1, the device 14 may convert the captured audio signals into two types of data: (i) audio fragments or LSH values generated from and representing the background audio/music, and (ii) text array generated from speech-to-text conversion of the human speech content in the video being played. The technique of locality sensitive hashing is known in the art and, hence, additional discussion of generation of LSH tables is not provided herein for the sake of brevity. The device 14 may send the generated data (i.e., LSH values and text array) to the remote server 12 via a communication network (not shown) as indicated by arrow 16 in FIG. 1. Upon analysis of the received: data (as discussed in more detail below), the server 12 may provide the device 14 with information about an estimated position indicating what part of the audio-visual content is currently being played on the video playback system, as indicated by arrow 18 in FIG. 1. The second screen app 15 in the device 14 may use this information to provide targeted content (for example, web advertisements, trivia, and the like) that is synchronized with the current play-through location of the audio-visual content the user of the device 14 may be simultaneously watching on the video playback system.

It is noted here that the terms “location” (as in “estimated location information”) and “position” (as in “estimated position information”) may be used interchangeably herein to refer to a play-through location or playback position of the audio-visual content currently being played on or through a video playback system.

In one embodiment, the second screen app 15 in the user device 14 may initiate the estimation (of the current play-through location) upon receipt of an indication for the same from the user (for example, a user input via a touch-pad or a key stroke). In another embodiment, the second screen app 15 may automatically and continuously monitor the audio-visual content and periodically (or continuously) request synchronizations (i.e., estimations of current video playback positions) from the remote server 12.

The second screen app module 15 may be an application software provided by the user's cable/satellite TV operator and may be configured to enable the user device 14 to request estimations of play-through locations from the remote server 12 and consequently deliver targeted content (for example, web-based delivery using the Internet) to the user device 14. Alternatively, the program code for the second screen module 15 may be developed by a third party or may be an open source software that may be suitably modified for use with the user's video playback system. The second screen module 15 may be downloaded from a website (for example, the cable service provider's website, an audio-visual content provider's website, or a third party software developer's website) or may be supplied on a data storage medium (for example, a compact disc (CD) or DVD or a flash memory) for download on the appropriate user device 14. The functionality provided by the second screen app module 15 may be suitably implemented in software by one skilled in the art and, hence, additional design details of the second screen app module 15 are not provided herein for the sake of brevity.

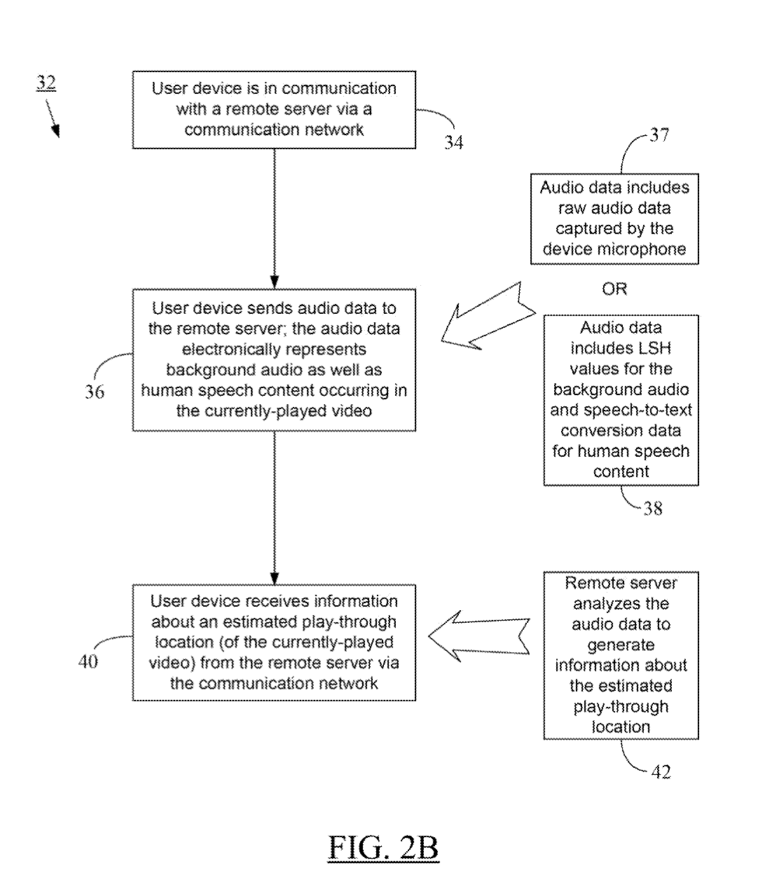

FIG. 2A is an exemplary flowchart 20 depicting various steps performed by the remote server 12 in FIG. 1 according to one embodiment of the present disclosure. As indicated at block 22, the remote server 12 may be in communication with the user device 14 via a communication network (for example, an IP (Internet Protocol) or TCP/IP (Transmission Control Protocol/Internet Protocol) network such as the Internet) (not shown). At block 24, the remote server 12 receives audio data from the user device 14. As mentioned earlier, the audio data may electronically represent back ground audio as well as human speech content occurring in the video currently being played through a video play-out device (for example, a cable TV or an SIB-connected TV). In one embodiment, as indicated at block 25, the audio data may include raw audio data (for example, in a Waveform Audio File Format (WAV file) or as an MP3 file) captured by the microphone (not shown) of the user device 14. In that case, the server 12 may generate the necessary LSH values and text array data from such raw data (during the analysis step at block 28). In another embodiment, the audio data may include LSH values and text array data generated by the user device 14 (as in case of the embodiment in FIG. 1) and supplied to the server as indicated at block 26. Upon receipt of the audio data (whether raw (unprocessed) or processed), the server 12 may analyze the audio data to generate information about the estimated play-through location of the currently-played video, as indicated at block 28. In case of raw audio data, as noted earlier, this analysis step may also include pre-processing of the raw audio data into corresponding LSH values and text array data before performing the estimation of the current play-through location. Upon conclusion of its analysis, the server 12 may have the estimated position information available, which the server 12 may then send to the user device 14 via the communication network (as indicated at block 30 in FIG. 2A and also indicated by arrow 18 in FIG. 1). Based on this estimation of the current play-through location, the second screen app 15 in the user device 14 may carry out provisioning of targeted content to the user.

FIG. 2B is an exemplary flowchart 32 depicting various steps performed by the user device 14 in FIG. 1 according to one embodiment of the present disclosure. The flowchart 32 in FIG. 2B may be considered a counterpart of the flowchart 20 in FIG. 2A. Like block 22 in the flowchart 20, the initial block 34 in the flowchart 32 also indicates that the user device 14 may be in communication with the remote server 12 via a communication network (for example, the Internet). Either upon a request from a user or automatically, the second screen app 15 in the user device 14 may initiate transmission of audio data to the remote server 12, as indicated at block 36. Like blocks 24-26 in FIG. 2A, blocks 36-38 in FIG. 2B also indicate that the audio data electronically represents the background audio/music as well as the human speech content occurring in the currently-played video (block 36) and that the audio data may be in the form of either raw audio data as captured by a microphone of the device 14 (block 37) or “processed” audio data generated by the user device 14 and containing LSH values (representing the background audio) and text array data (i.e., data generated from speech-to-text conversion of the human speech content) (block 38). In due course, the user device 14 may receive from the server 12 information about the estimated play-through location (block 40), wherein the estimated play-through location indicates what part of the audio-visual content is currently being played on a user's video playback system. As part of the generation and delivery of the estimated position information, the remote server 12 may analyze the audio data received from the user device 14 as indicated at block 42 in FIG. 2B. As before, based on this estimation of the current play-through location, the second screen app 15 in the user device 14 may carry out provisioning of targeted content to the user.

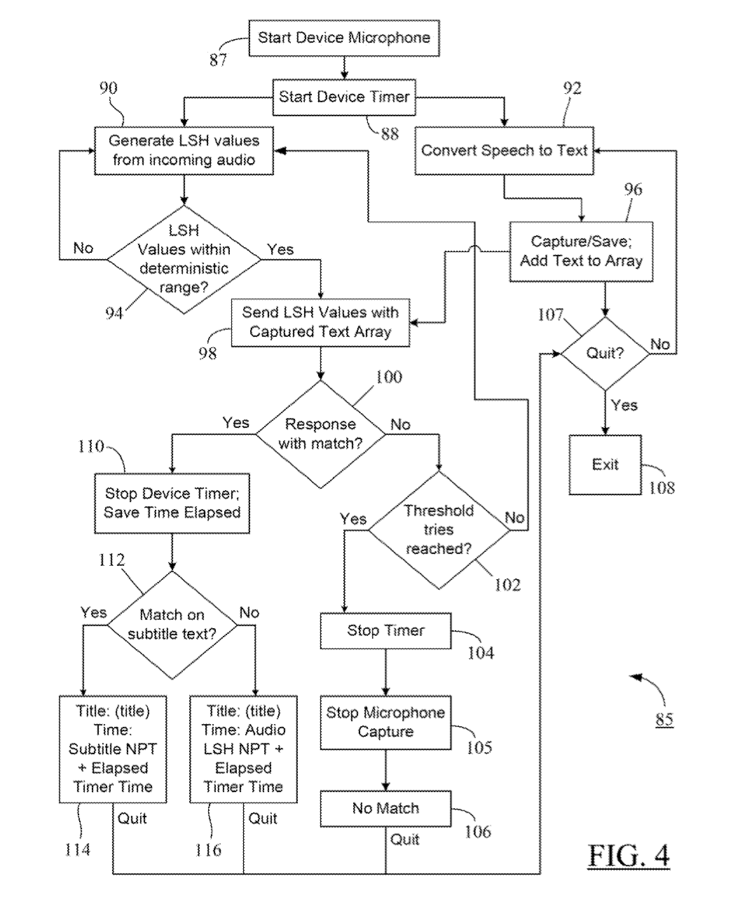

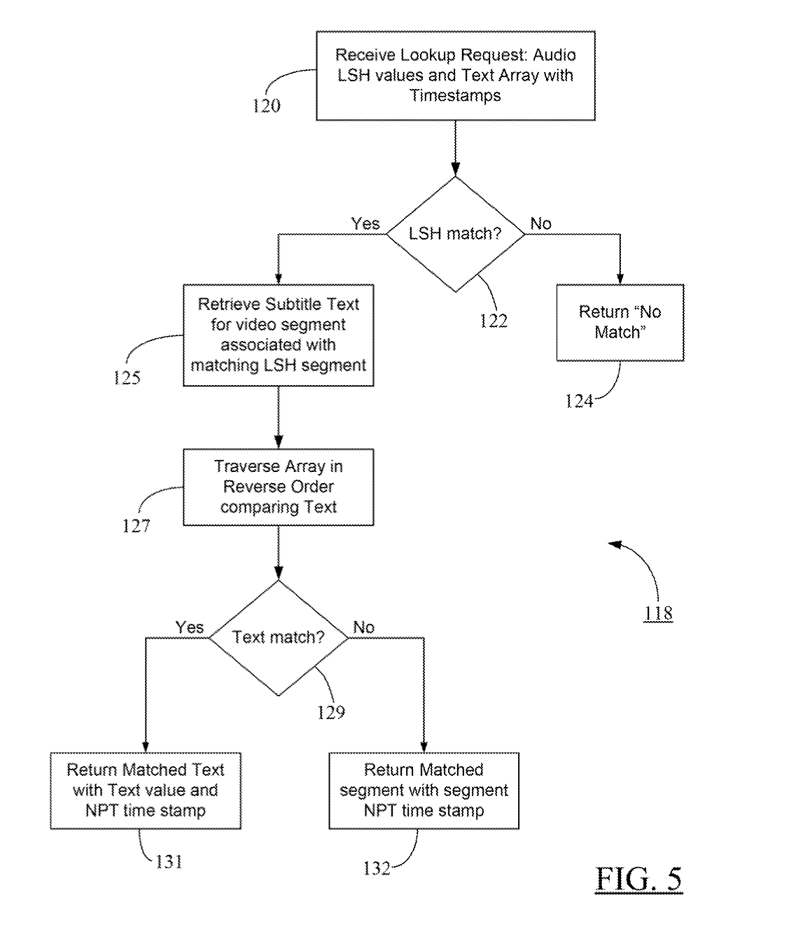

It is noted here that FIGS. 2A and 2B provide a general outline of various steps performed by the remote server 12 and the user device 14 as part of the video location estimation procedure according to particular embodiments of the present disclosure. A more detailed depiction of those steps is provided in FIGS. 4 and 5 discussed later below.

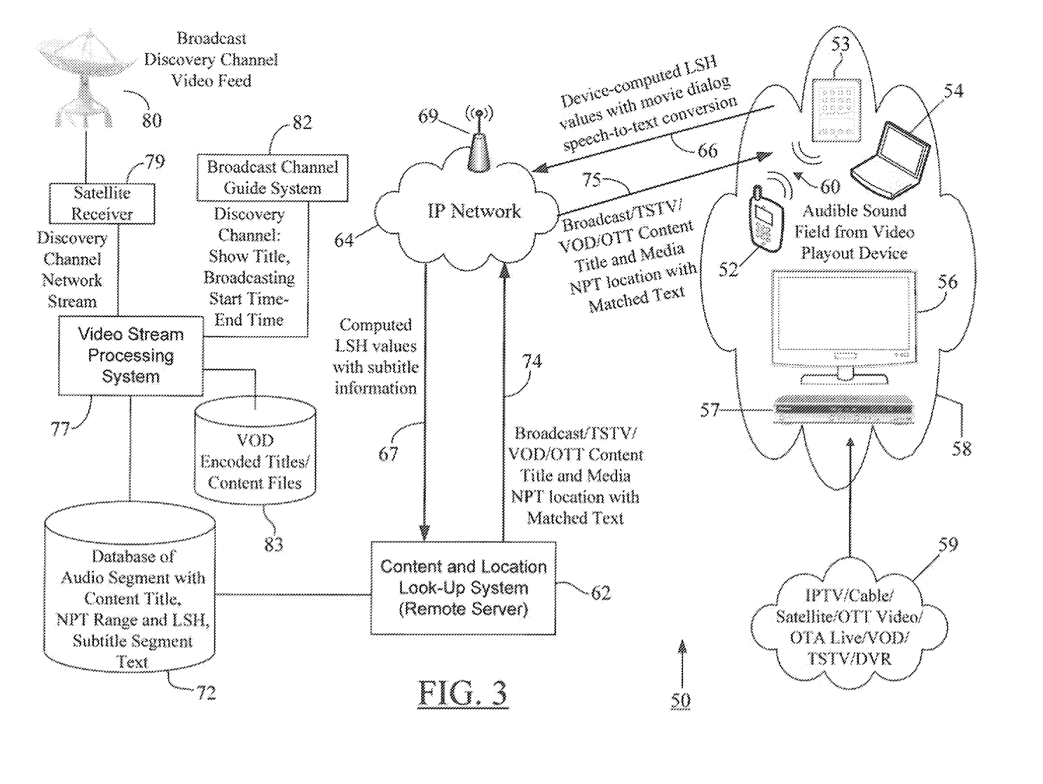

FIG. 3 illustrates exemplary details of the video recognition system generally shown in FIG. 1 according to one embodiment of the present disclosure. Because of additional details in FIG. 3, the system shown in FIG. 3 is given a different reference numeral (i.e., numeral “50”) than the numeral “10” used for the system in FIG. 1. In the embodiment of FIG. 3, the system 50 is shown to include a plurality of user devices—some examples of which include a UE or smartphone 52, a tablet computer 53, and a laptop computer 54—in the vicinity of a video playback system comprising of a television 56 connected to a set-top-box (STB) 57 (or a similar signal receiving/decoding unit). The user devices 52-54 may be web-enabled or Internet Protocol (IP)-enabled. It is noted here that the exemplary user devices 52-54 are shown in FIG. 3 for illustrative purpose only. It does not imply that the user has to either use all of these devices to communicate with the remote server (i.e., the look-up system 62 discussed later below or the remote server 12 in FIG. 1) or that the remote server communicates with only the type of user devices shown.

It is noted here that the terms “video playback system” and “video play-out device” may be used interchangeably herein to refer to a device where the audio-visual content such as a movie, a television show, and the like) is currently being played. Depending on the service provider and type of service (for example, cable or non-cable), such video playback device may include a TV alone (for example, a digital High Definition Television (HDTV)) or a TV in combination with a provider-specific content receiver (for example, a Customer Premises Equipment (CPE) (such as a computer (not shown) or a set-top box 57) that is capable of receiving audio-visual content through RF signals and converting the received signals into signals that are compatible with display devices such as analog/digital televisions or computer monitors) or any other non-TV video playback unit. However, for ease of discussion, the term “television” is primarily used herein as an example of the “video playback system”, regardless of whether the TV is operating as a CPE itself or in combination with another unit. Thus, it is understood that although the discussion below is given with reference to a TV as an example, the teachings of the present disclosure remain applicable to many other types of non-television audio-visual content players (for example, computer monitors, video projection devices, movie theater screens, etc) functioning as video (or audio-visual) playback systems.

The user devices 52-54 and the video playback system (TV 56 and/or the STB receiver 57) may be present at a location 58 that allows them to be in close physical proximity with each other. The location 58 may be a home, a hotel room, a dormitory room, a movie theater, and the like. In other words, in certain embodiments, a user of the user device 52-54 may not be the owner/proprietor or registered customer/subscriber of the video playback system, but the user device can still invoke second screen apps because of the device's close proximity to the video playback system.

The video playback system (here the TV 56) may receive cable-based as well as non-cable based audio-visual content. As indicated by cloud 59 in FIG. 3, such content may include, for example, Internet Protocol TV (IPTV) content, cable TV programming, satellite or broadcast TV channels, Over-The-Top (OTT) streaming video from non-cable operators like Vudu and Netflix, Over-The-Air (OTA) live programming, Video-On-Demand (VOD) content from a cable service provider or a non-cable network operator, Time Shifted Television (TSTV) content, programming delivered from a DVR or a Personal Video Recorder (PVR) or a Network-based Personal Video Recorder (NPVR), a DVD playback content, and the like.

As indicated by arrow 60 in FIG. 3, an audible sound field may be generated from the video play-out device 56 when an audio-visual content is being played thereon. A user device (for example, the tablet 53) hosting a second screen app (like the second screen app 15 in FIG. 1) may capture the sound waves in the audio field either automatically (for example, at pre-determined time intervals) or upon a trigger/input from the user (not shown). As mentioned before, a microphone (not shown) in the user device 53 may capture the sound waves and convert them into electronic signals representing the audio content in the sound waves (i.e., background audio/music and human speech). In the embodiment of FIG. 3, the user device 53 may compute LSH values (from the received background audio) and text array data (from speech-to-text conversion of the received human speech content), and send them to a remote server (referred to as a content and location look-up system 62 in FIG. 3) in the system 50 via a communication network 64 (for example, an IP or TCP/IP based network such as the Internet) as indicated by arrows 66 and 67. In one embodiment, the user devices 52-54 may communicate with the IP network 64 using TCP/IP-based data communication. The IP network 64 may be, for example, the Internet (including the world wide web portion of the Internet) including portions of one or more wireless networks as part thereof (as illustrated by an exemplary wireless access point 69) to receive communications from a wireless user device such as the cell phone (or smart phone) 52 or wirelessly-connected laptop computer 54 or tablet 53. In one embodiment, the cell phone 52 may be WAP (Wireless Access Protocol)-enabled to allow IP-based communication with the IP network 64. It is noted here that the text array data (at arrow 66) may represent subtitle information associated with the human speech in the video currently-being played (as stated in the text accompanying arrow 67). The transmission of LSH values and text array data may be in a wireless manner, for example, through the wireless access point 69, which may be part of the IP network 64 and in communication with the user device 53 (and probably with the server 62 as well). As mentioned earlier, instead of the processed audio data (containing LSH values and text array data), in one embodiment, the user device 53 may just send the raw audio data (output by the microphone of the user device) to the remote server 62 via the network 64.

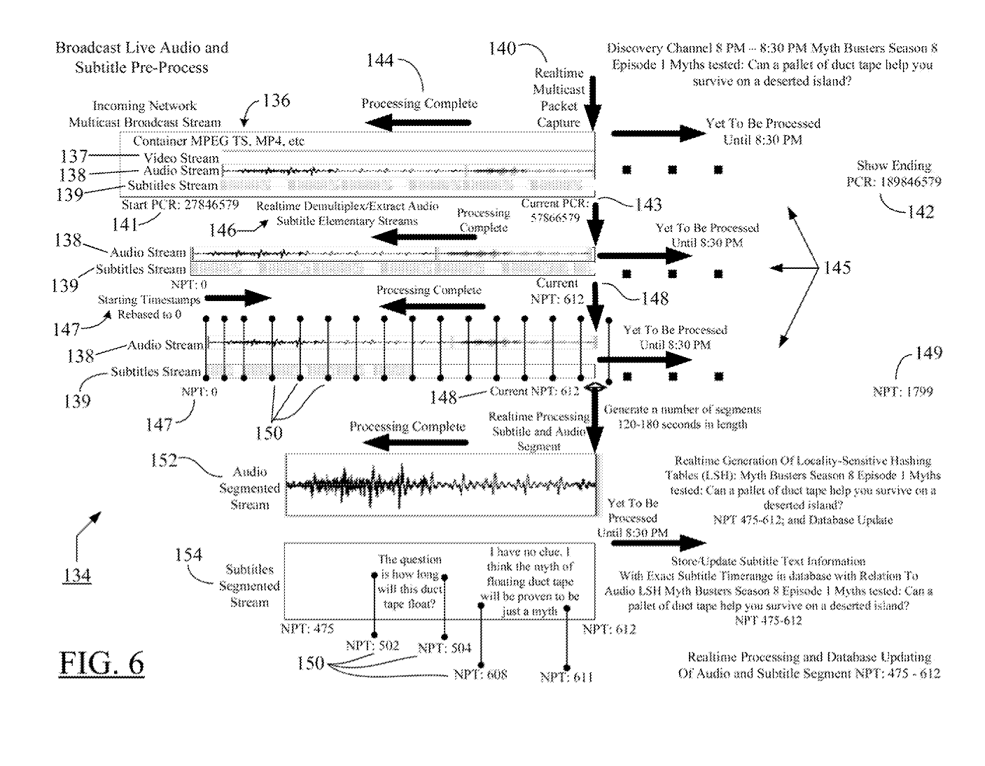

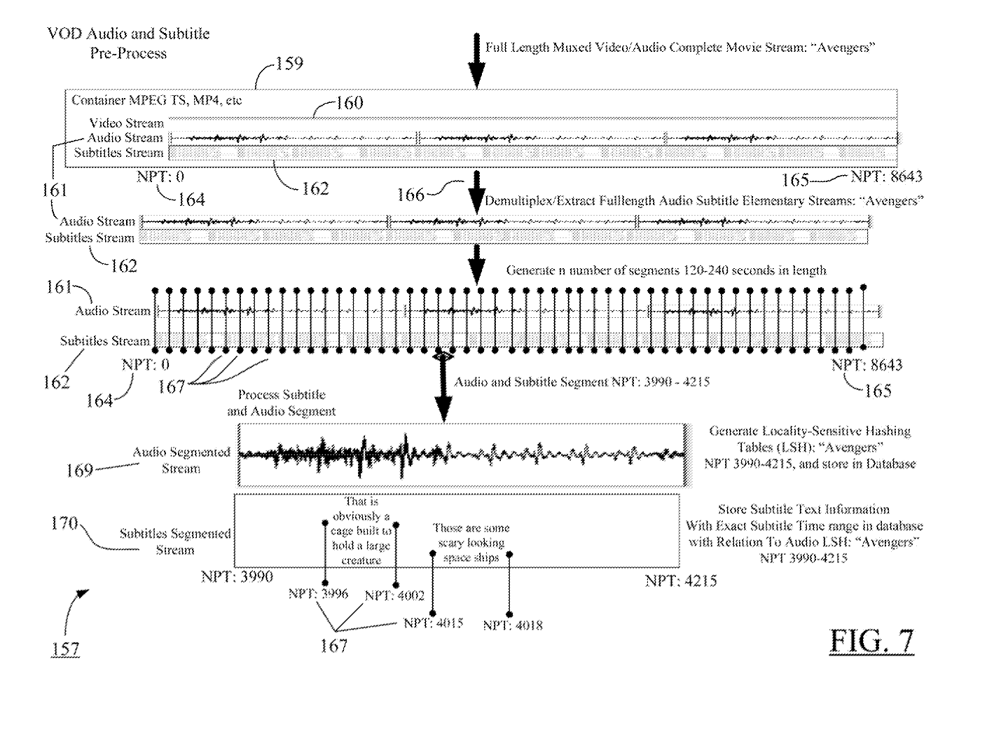

Upon receipt of the audio data from the user device 53, the remote server 62 may perform content and location look-up using a database 72 in the system 50 to provide an accurate estimation of what part of the audio-visual content is currently being played on the video playback system 56. In case of raw (unprocessed) audio data, the remote server 62 may first distinguish background audio and human speech content embedded in the received audio data and may then generate the corresponding LSH values and text array before accessing the database 72. The database 72 may be a huge (searchable) index of a variety of audio-visual content—for example, index of live broadcast TV airings; index of pre-recorded television shows, VOD programming, and commercials; index of commercially available DVDs, movies, video games; and the like. In one embodiment, the database 72 may contain information about known audio/music clips (whether occurring in TV shows, movies, etc.) including their corresponding LSH and Normal Play Time (NPT) values, titles of audio-visual contents associated with the audio clips, information identifying video data (such as video segments) corresponding to the audio clips and the range of NPT values (discussed in more detail with reference to FIGS. 6-7) associated with such video data, and information about known video segments (for example, general theme, type of video such as movie, documentary, music video, and the like), actors, etc.) and their corresponding subtitles (in a searchable text form). In one embodiment, to conserve storage space, the content stored in the database 72 may be encoded and/or compressed. The database 72 and the look-up system 62 may be managed, operated, or supported by a common entity (for example, a cable service provider). Alternatively, one entity may own or operate the look-up system 62 whereas another entity may own/operate the database 72, and the two entities may have appropriate licensing or operating agreement for database access. Other similar or alternative commercial arrangements may be envisaged for ownership, operation, management, or support of various component systems shown in FIG. 3 (for example, the server 62, the database 72, and the VOD database 83).

As part of analysis of the received audio data (containing LSH values and text array) for estimation of the current playback position, the look-up system 62 may first search the database 72 using the received LSH values to identify an audio clip in the database 72 having the same (or substantially similar) LSH values. The audio clips may have been stored in the database 72 in the form of audio fragments represented by respective LSH and NPT values (as discussed later, for example, with reference to FIGs. 6-7). In this manner, the audio clip associated with the received LSH values may be identified. Thereafter, the look-up system 62 may search the database 72 using information about the identified audio clip (for example, NPT values) to obtain an estimation of a video segment associated with the identified audio clip—for example, a video segment having the same NPT values. The video segment may represent a ballpark (“coarse”) estimate (of the current play-through location), which may be “fine-tuned” using the received text array data. In one embodiment, using the video segment as a starting point, the remote server 62 may further analyze the received text array to identify an exact (or substantially accurate) estimate of the current play-through location within that video segment. As part of this additional analysis, the remote server 62 may search the database 72 using information about the identified video segment (for example, segment-specific NPT values and/or segment-specific audio clip) to retrieve from the database 72 subtitle information associated with the identified video segment, and then compare the retrieved subtitle information with the received text array to find a matching text therebetween. The server 62 may determine the estimated play-through location (to be reported to the user device 53) as that location within the video segment which corresponds to the matching text.

In this manner, a two-stage or hierarchical analysis may be carried out by the remote server 62 to provide a “fine-tuned”, substantially-accurate estimation of the current play-through location in the audio-visual content on the video playback system 56. Additional details of this estimation process is provided later with reference to discussion of FIG. 4 (user device-based processing) and FIG. 5 (remote server-based processing),

Upon identification of the current play-through location, the look-up system 62 may send relevant video recognition information (i.e., estimated position information) to the user device 53 via the IP network 64 as indicated by arrows 74-75 in FIG. 3. In one embodiment, such estimated position information may include one or more of the following: title of the audio-visual content currently being played (as obtained from the database 72), identification of an entire video segment (for example, between a pair of NPT values) containing the background audio (as reported through the LSH values sent by the user device), an NPT value (or a range of NPT values) for the identified video segment, identification of a subtitle text within the video segment that matches the human speech content (received as part of the audio data from the user device in the form of, for example, text array), and an NPT value (or a range of NPT values) associated with the identified subtitle text within the video segment. It is noted here that the arrows 74-75 in FIG. 3 mention just a few examples of the types of audio-visual content (for example, broadcast TV, TSTV, VOD, OTT video, and the like) that may be “handled” by the content and location look-up system 62.

The system 50 in FIG. 3 may also include a video stream processing system (VPS) 77 that may be configured to “fill” (or populate) the database 72 with relevant (searchable) content. In one embodiment, the VPS 77 may be coupled to (or in communication with) such components as a satellite receiver 79 (which may receive live satellite broadcast video feed in the form of analog or digital channels from a satellite antenna 80), a broadcast channel guide system 82, and a VOD database 83. In the context of an exemplary TV channel (for example, the Discovery Channel), the satellite receiver 79 may receive a live broadcast video feed of this channel from the satellite antenna 80 and may send the received video feed (after relevant pre-processing, decoding, etc.) to the VPS 77. Prior to processing the received live video data, the VPS 77 may communicate with the broadcast channel guide system 82 to obtain therefrom content-identifying information about the Discovery Channel-related video data currently being received from the satellite receiver 79. In one embodiment, the channel guide system 82 may maintain a “catalog” or “channel guide” of programming details (for example, titles, broadcasting times, producers, and the like) of all different TV channels (cable or non-cable) currently being aired or already-aired in the past. For the exemplary Discovery Channel video feed, the VPS 77 may access the guide system 82 with initial channel-related information received from the satellite received 79 (for example, channel number, channel name, current time, etc.) to obtain from the guide system 82 such content-identifying information as the current show's title, the start time and the end time of the broadcast, and so on. The VPS 77 may then parse and process the received audio-visual content (from the satellite video feed) to generate LSH values for the background audio segments (which may include background music, if present) in the content as well as subtitle text data for the associated video. It is noted here that no music recognition is attempted when background audio segments are generated. In one embodiment, if “Line 21 information” (i.e., subtitles for human speech content and/or closed captioning for audio portions) for the current channel is available in the video feed from the satellite receiver 79, the VPS 77 may not need to generate subtitle text, but can rather use the Line 21 information supplied as part of the channel broadcast signals. In the discussion below, the Line 21 information is used as an example only. Additional examples of other subtitle formats are given at http://en.wikipedia.orgiwiki/Subtitle_(captioning), In particular embodiments, the subtitle information in such other formats (for example, teletext, Subtitles for the Deaf or Hard-of-hearing (SDH), Synchronized Multimedia Integration Language (SMIL), etc.) may be suitably used as well. In any event, the VPS 77 may also assign the relevant content title and NPT ranges (for audio and video segments) using the content-identifying information (for example, title, broadcast start/stop times, and the like) received from the guide system 82. The VPS may then send the audio and video segments along with their identifying information (for example, title, LSH values, NPT ranges, etc.) to the database 72 for indexing. Additional details of indexing of a live video feed are shown in FIG. 6 (discussed below).

Like the live video processing discussed above, the VPS 77 may also process and index pre-stored VOD content (such as, for example, movies, television shows, and/or other programs) from the VOD database 83 and store the processed information (for example, generated audio and video segments, their content-identifying information such as title, LSH values, and/or NPT ranges) in the database 72. In one embodiment, the VOD database 83 may contain encoded files of a VOD program's content and title. The VPS 77 may retrieve these files from the VOD database 83 and process them in the manner similar to that discussed above with reference to the live video feed to generate audio fragments identified by corresponding LSH values, video segments and associated subtitle text arrays, NPT ranges of audio and/or video segments, and the like. Additional details of indexing of a pre-stored VOD content are shown in FIG. 7 (discussed below).

In one embodiment, the VPS 77 may be owned, managed, or operated by an entity (for example, a cable TV service provider, or a satellite network operator) other than the entity operating or managing the remote server 62 (and/or the database 72). Similarly, the entity offering the second screen app on a user device may be different from the entity or entities managing various components shown in FIG. 3 (for example, the remote server 62, the VOD database 83, the VPS 77, the database 72, and the like). As mentioned earlier, all of these entities may have appropriate licensing or operating agreements therebetween to enable the second screen app (on the user device 53) to avail of the video location estimation capabilities of the remote server 62. Generally, who owns or manages a specific system component shown in FIG. 3 is not relevant to the overall video recognition solution discussed in the present disclosure.

It is noted here that each of the processing entity 52-54, 62, 77 in the embodiment of FIG. 3 and the entities 12, 14 in the embodiment of FIG. 1 may include a respective memory (not shown) to store the program code to carry out the relevant processing steps discussed hereinbefore. An entity's processor(s) (not shown) may invoke/execute that program code to implement the desired functionality. For example, in one embodiment, upon execution by a processor (not shown) in the user device 14 in FIG. 1, the program code for the second screen app 15 may cause the processor in the user device 14 to perform various steps illustrated in FIG. 2B and FIG. 4. Any of the user devices 52-54 may host a similar second screen app that, upon execution, configures the corresponding user device to perform various steps illustrated in FIG. 2B and FIG. 4. Similarly, one or more processors in the remote server 12 (FIG. 1) or the remote server 62 (FIG. 3) may execute relevant program code to carry out the method steps illustrated in FIG. 2A and FIG. 5. The VPS 77 may also be similarly configured to perform various processing tasks ascribed thereto in the discussion herein (such as, for example, the processing illustrated in FIGS. 6-7 discussed below). Thus, the servers 12, 62, and the user devices 14, 52-54 (or any other processing device) may be configured (in hardware, via software, or both) to carry out the relevant portions of the video recognition methodology illustrated in the flowcharts in FIGS. 2A-28 and FIGS. 4-7. For ease of illustration, architectural details of various processing entities are not shown. It is noted, however, that the execution of a program code (for example, by a processor in a server) may cause the related processing entity to perform a relevant function, process step, or part of a process step to implement the desired task. Thus, although the servers 12, 62, and the user devices 14, 52-54 (or other processing entities) may be referred to herein as “performing,” “accomplishing,” or “carrying out” a function or process, it is evident to one skilled in the art that such performance may be technically accomplished in hardware and/or software as desired. The servers 12, 62, and the user devices 14, 52-54 (or other processing entities) may include a processor(s) such as, for example, a general purpose processor, a special purpose processor, a conventional processor, a digital signal processor (DSP), a plurality of microprocessors (including distributed processors), one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Furthermore, various memories (for example, the memories in various processing entities, databases, etc.) (not shown) may include a computer-readable data storage medium. Examples of such computer-readable storage media include a Read Only Memory (ROM), a Random Access Memory (RAM), a digital register, a cache memory, semiconductor memory devices, magnetic media such as internal hard disks, magnetic tapes and removable disks, magneto-optical media, and optical media such as CD-ROM disks and Digital Versatile Disks (DVDs). Thus, the methods or flow charts provided herein may be implemented in a computer program, software, or firmware incorporated in a computer-readable storage medium (not shown) for execution by a general purpose computer (for example, computing units in the user devices 14, 52-54) or a server (such as the servers 12, 62).

FIG. 4 shows an exemplary flowchart 85 depicting details of various steps performed by a user device (for example, the user device 14 in FIG. 1 or the tablet 53 in FIG. 3) as part of the video recognition procedure according to one embodiment of the present disclosure. In one embodiment, upon execution of the program code of a second screen app (for example, the app 15 in FIG. 1) hosted by the user device, the second screen app may configure the device to perform the steps illustrated in FIG. 4. The second screen app may configure the device to either automatically or through a user input initiate the video location estimation procedure according to the teachings of the present disclosure. Initially, the second screen app may turn on a microphone (not shown) in the user device (block 87 in FIG. 4) to enable the user device to start receiving audio signals from the video playback system (for example, the TV 56 in FIG. 3) through its microphone. The second screen app may also start a device timer (in software or hardware) (block 88 in FIG. 4). As discussed below, the timer values may be used for time-based correction of the estimated play-through position for improved accuracy. The device may then start generating LSH values (block 90) from the incoming audio (as captured by the microphone) to represent the background audio content and may also start converting the human speech content in the incoming audio into text data (block 92). In one embodiment, the user device may continue to generate LSH values until the length of the associated audio segment is within a pre-determined range (for example, an audio segment of 150 seconds in length, or an audio segment of 120 to 180 seconds in length) as indicated at block 94. The device may also continue to capture and save corresponding text data to an array (block 96) and then send the LSH values (having a deterministic range) with the captured text array to a remote server (for example, the remote server 12 in FIG. 1 or the remote server 62 in FIG. 3) for video location estimation according to the teachings of the present disclosure (block 98). In one embodiment, the LSH values and the text array data may be time-stamped by the device (using the value from the device timer) before sending to the remote server.

The processing at the remote server is discussed earlier before with reference to FIG. 3, and is also discussed later below with reference to the flowchart 118 in FIG. 5. When the user device receives a response from the remote server, the device first determines at block 100 whether the response indicates a “match” between the LSH values (and, possibly, the text array data) sent by the device (at block 98) and those looked-up by the server in a database (for example, the database 72 in FIG. 3). If the response does not indicate a “match,” the user device (through the second screen app in the device) may determine at decision block 102 whether a pre-determined threshold number of attempts is reached. If the threshold number is not reached, the device may continue to generate LSH values and capture text array data and may keep sending them to the remote server as indicated at blocks 90, 92, 94, 96, and 98. However, if the device has already attempted sending audio data (including LSH values and text array) to the remote server for the threshold number of times, the device may conclude that its video location estimation attempts are unsuccessful and may stop the timer (block 104) and microphone capture (block 105) and indicate a “no match” result to the second screen app (block 106) before quitting the process in FIG. 4 as indicated by blocks 107-108. Alternatively, the second screen app may not quit after first iteration, but may continue the audio data generation, transmission, and server response processing aspects for a pre-determined time with the hope of receiving a matching response from the server and, hence, having a chance to deliver targeted content on the user device in synchronization with the content delivery on the TV 56 (FIG. 3). If needed in future, the second screen app may again initiate the process 85 in FIG. 4—either automatically or in response to a user input. In one embodiment, the second screen app may periodically initiate synchronization (for example, after every 5 minutes or 10 minutes), for example, to account for a possible change in the audio-visual content being played on the TV 56 or to compensate for any loss of synchronization due to time lapse.

On the other hand, if the remote server's response indicates a “match” at decision block 100, the device may first stop the device timer and save the timer value (indicating the elapsed time) as noted at block 110. The matching indication from the server may indicate a “match” only on the LSH values or a “match” on LSH values as well as text array data sent by the device (at block 98). The device may thus process the server's response to ascertain at block 112 whether the response indicates a “match” on the text array data. A “match” on the text array data indicates that the server has been able to find from the database 72 not only a video segment (corresponding to the audio-visual content currently being played), but also subtitle text within that video segment which matches with at least some of the text data sent by the user device. In other words, a match on the subtitle text provides for more accurate estimation of location within the video segment, as opposed to a match only on the LSH values (which would provide an estimation of an entire video segment, and not a specific location within the video segment).

When the remote server's response indicates a “match” on subtitle text (at block 112), the second screen app on the user device may retrieve from the server's response the title (supplied by the remote server upon identification of a “matching” video segment) and an NPT value (or a range of NPT values) associated with the subtitle text within the video segment identified by the remote server (block 114). As also indicated at block 114, the second screen app may then augment the received NPT value with the elapsed time (as measured by the device timer at block 110) so as to compensate for the time delay occurring between the transmission of the LSH values and text array (from the user device to the remote server) and the reception of the estimated play-through location information from the remote server. The elapsed time delay may be measured as the difference between the starting value of the timer (at block 88) and the ending value of the timer (at block 110). This time-based correction thus addresses delays involved in backend processing (at the remote server), network delays, and computational delays at the user device. In one embodiment, the remote server's response may reflect the time stamp value contained in the audio data originally sent from the user device at block 98 to facilitate easy computation of elapsed time for the device request associated with that specific response. This approach may be useful to facilitate proper timing corrections, especially when the user device sends multiple look-up requests successively to the remote server. A returned timestamp may associate a request with its own timer values.

Due to the time-based correction, the second screen app in the user device can more accurately predict the current play-through location because the location identified in the response from the server may not be the most current location, especially when the (processing and propagation) time delay is non-trivial (for example, greater than a few milliseconds). The server-supplied location may have been already gone from the display (on the video playback system) by the time the user device receives the response from the server. The time-based correction thus allows the second screen to “catch up” with the most recent scene being played on the video playback system even if that scene is not the estimated location received from the remote server.

When the remote server's response does not indicate a “match” on subtitle text (at block 112), the second screen app on the user device may retrieve from the server's response the title (supplied by the remote server upon identification of a “matching” video segment) and, an NPT value for the beginning of the “matching” video segment (or a range of NPT values for the entire segment) (block 116). It is observed that the estimated location here refers to the entire video segment, and not to a specific location within the video segment as is the case at block 114. Normally, as mentioned earlier, a video segment may be identified through a corresponding background audio/music content. And, such background audio clip may be identified (in the database 72) from its corresponding LSH values. Hence, the NPT value(s) for the video segment at block 116 may in fact relate to the LSH and NPT value(s) of the associated background audio clip (in the database 72). Furthermore, as in case with block 114, the second screen app may also apply a time-based correction at block 116 to at least partially improve the estimation of current play-through location despite the lack of a match on subtitle text.

Upon identifying the current play-through location (with fine granularity at block 114 or with less specificity or coarse granularity at block 116), the second screen app may instruct the device to turn off its microphone capture and quit the process in FIG. 4 as indicated by blocks 107-108. The second screen app may then use the estimated location information to synchronize its targeted content delivery with the video being played on the TV 56 (FIG. 3). Alternatively, the second screen app may not quit after first iteration, but may continue the audio data generation, transmission, and server response processing aspects for a pre-determined time to obtain a more robust synchronization. If needed in future, the second screen app may again initiate the process 85 in FIG. 4—either automatically or in response to a user input. In one embodiment, the second screen app may periodically initiate synchronization (for example, after every 5 minutes or 10 minutes), for example, to account for a possible change in the audio-visual content being played on the TV 56 or to compensate for any loss of synchronization due to time lapse.

FIG. 5 is an exemplary flowchart 118 depicting details of various steps performed by a remote server (for example, the remote server 12 in FIG. 1 or the server 62 in FIG. 3) as part of the video recognition procedure according to one embodiment of the present disclosure. FIG. 5 may be considered a counterpart of FIG. 4 because it depicts operational aspects from the server side which complement the user device-based process steps in FIG. 4. Initially, at block 120, the remote server may receive a look-up request from the user device (for example, the user device 53 in FIG. 3) containing audio data (for example, LSH values and text array). As mentioned earlier with reference to FIG. 4, in one embodiment, the audio data may contain a timestamp to enable identification of proper delay correction to be applied (by the user device) to the corresponding response received from the remote server (as discussed earlier with reference to blocks 114 and 116 in FIG. 4). In the embodiment where the server receives raw audio data from the user device, the server may first generate corresponding LSH values and text array prior to proceeding further, as discussed earlier (but now shown in the embodiment of FIG. 5). Upon receiving the look-up request at block 120, the remote server may access a database (for example, the database 72 in FIG. 3) to check if the received LSH values match with the LSH values for any audio fragment (or audio clip) in the database (block 122). If no match is found, the server may return a “no match” indication to the user device (block 124). This “no mach” indication intimates the user device that the server has failed to find an estimated position (for the currently-played video) and, hence, the server cannot generate any estimated position information. The second screen app in the user device may process this failure indication in the manner discussed earlier with reference to blocks 102 and 104-108 in FIG. 4.

On the other hand, if the server finds an LSH match at block 122, that indicates presence of an audio segment (in the database 72) having the same LSH values as the background audio in the audio-visual content currently being played on the video playback system 56. Using one or more parameters associated with this audio segment for example, NPT values), the server may retrieve—from the database 72—information about a corresponding video segment (for example, a video segment having the same NPT values, indicating that the video segment is associated with the identified audio segment) (block 125). Such information may include, for example, title associated with the video segment, subtitle text for the video segment (representing human speech content in the video segment), the range of NPT values for the video segment, and the like. The identified video segment provides a ballpark estimate of where in the movie (or other audio-visual content currently being played on the TV 56) the audio clip audio segment is from. With this ballpark estimate as a starting point, the server may match the dialog text (received from the user device 53 at block 120) with subtitle information (for the video segment identified from the database 72) for identification of a more accurate location within that video segment. This allows the server to specify to the user device a more exact location in the currently-played video, rather than generally suggesting the entire video segment (without identification of any specific location within that segment). The server may compare text data received from the user device with the subtitle text array retrieved from the database to identify any matching text therebetween. In one embodiment, the server may traverse the subtitle text (retrieved at block 125) in the reverse order (for example, from the end of a sentence to the beginning of the sentence) to quickly and efficiently find a matching text that is closest in time (block 127). Such matching text thus represents the (time-wise) most-recently occurring dialog in the currently-played video. If a match is found (block 129), the server may return the matched text with its (subtitle) text value and NPT time range (also sometimes referred to hereinbelow as “NPT time stamp”) to the user device (block 131) as part of the estimated position information. The server may also provide to the user device the title of the audio-visual content associated with the “matching” video segment. Based on the NPT value(s) and subtitle text values received at block 131, the second screen app in the user device may figure out what part of the audio-visual content is currently being played, so as to enable the user device to offer targeted content to the user in synchronism with the video display on the TV 56. In one embodiment, the user device may also apply time delay correction as discussed earlier with reference to block 114 in FIG. 4.

However, if a match is not found at block 129, the server may instead return the entire video segment (as indicated by, for example, its starting NPT time stamp or a range of NPT values) to the user device (block 132) as part of the estimated position information. As noted with reference to the earlier discussion of block 116 in FIG. 4, a video segment may be identified through a corresponding background audio/music content. And, such background audio clip may be identified (in the database 72) from its corresponding LSH values. Hence, the NPT value(s) for the video segment at block 132 may in fact relate to the LSH and NPT value(s) of the associated background audio clip. The server may also provide to the user device the title of the audio-visual content associated with the “matching” video segment (retrieved at block 125 and reported at block 132). Based on the NPT value(s) received at block 132, the second screen app in the user device may figure out what part of the audio-visual content is currently being played, so as to enable the user device to offer targeted content to the user in synchronism with the video display on the TV 56. In one embodiment, the user device may also apply time delay correction as discussed earlier with reference to block 116 in FIG. 4.

FIG. 6 provides an exemplary illustration 134 showing how a live video feed may be processed according to one embodiment of the present disclosure to generate respective audio and video segments therefrom. In one embodiment, the processing may be performed by the VPS 77 (FIG. 3), which may then store the LSH values and NPT time ranges of the generated audio segment as well as subtitle text array and NPT values for the generated video segment in the database 72 for later access by the look-up system (or remote server) 62. The waveforms in FIG. 6 are illustrated in the context of an exemplary broadcast channel—for example, the Discovery Channel. More specifically, FIG. 6 depicts real-time content analysis for a portion of the following show aired between 8 pm and 8:30 pm on the Discovery Channel: Myth Busters, Season 8, Episode 1, Myths Tested: “Can a pallet of duct tape help you survive on a deserted island?” As discussed with reference to FIG. 3, the VPS 77 may receive live video feed of this audio-visual show from the satellite receiver 79. In one embodiment, that live video feed may be a multicast broadcast stream 136 containing a video stream 137, a corresponding audio stream 138 (containing background audio or music), and a subtitles stream 139 representing human speech content (for example, as Line 21 information mentioned earlier) of the video stream 137. All of these data streams may be contained in multicast data packets captured in real-time by the satellite receiver 79 and transferred to the VPS 77 for processing, as indicated at arrow 140. In one embodiment, the multicast data streams 136 may be in any of the known container formats for packetized data transfer—for example, the Moving Pictures Experts Group (MPEG) Layer 4 (MP4) format, or the MPEG Transport Stream (TS) format, and the like. The 30-minute video segment may have associated Program Clock Reference (PCR) values also transmitted in the video stream of the MPEG TS multicast stream. In FIG. 6, the starting (8 pm) and ending (8:30 pm) PCR values for the show are indicated using reference numerals “141” and “142”, respectively. The PCR value of the program portion currently being processed is indicated using reference numeral “143.” Furthermore, the processed portion of the broadcast stream is identified using the arrows 144, whereas the yet-to-be-processed portion (until 8:30 pm—i.e., when the show is over) is identified using arrows 145.

Initially, the VPS 77 (FIG. 3) may perform real-time de-multiplexing of the incoming multicast broadcast stream to extract audio stream 138 and subtitle stream 139, as indicated by reference numeral “146 in FIG. 6. In one embodiment, the video stream 137 may not have to be extracted because the remote server 62 receives only audio data from the user device (for example, the device 53 in FIG. 3). Thus, to enable the server 62 to “identify” video segment associated with the received audio data, the extracted audio stream 138 and the subtitle stream 139 may suffice. In one embodiment, for ease of indexing. NPT time ranges may be assigned to the de-multiplexed content 138-139. For practical reasons, the NPT time range is started with value zero (“0”) in FIG. 6 so that it becomes easy to identify the exact time in the current playing content based on when it began. Similarly, VOD content (in FIG. 7) also may be processed with NPT values beginning at zero (“0”), as discussed later. In FIG. 6, the starting NPT value (i.e., NPT=0) is noted using the reference numeral 147,” the NPT value of the current processing location (i.e., NPT=612) is noted using the reference numeral “148”, and the NPT value for the program's ending location (i.e., NPT=1799) is noted using the reference numeral “149.” The NPT time ranges are indicated using vertical markers 150. In one embodiment, each NPT time-stamp (or “NPT time range”) may represent one (1) second. In FIG. 6, two exemplary processed segments—an audio segment 152 and a corresponding subtitle segment 154—are shown along with their common set of associated NPT values (i.e., in the range of NPT=475 to NPT=612). Thus, in the embodiment of FIG. 6, the length or duration of each of these segments is 138 seconds (i.e., the number of time stamps between NPT 475 and NPT 612). It is understood that the entire program content may be divided into many such audio and subtitle segments (each having a duration in the range of 120 to 150 seconds). The selected range of NPT values is exemplary in nature. Any other suitable range of NPT values may be selected to define the length of an individual segment (and, hence, the total number of segments contained in the audio-visual program).

In case of the audio segment 152, the VPS 77 may also generate an LSH table for the audio segment 152 and then update the database 72 with the LSH and NPT values associated with the audio segment 152. In a future search of the database, the audio segment 152 may be identified when matching LSH values are received (for example, from the user device 53). In one embodiment, the VPS 77 may also store the original content of the audio segment 152 in the database 72. Such storage may be in an encoded and/or compressed form to conserve memory space.

In one embodiment, the VPS 77 may store the content of the video stream 137 in the database 72 by using the video stream's representational equivalent—i.e., all of the subtitle segments (like the segment 154) generated during the processing illustrated in FIG. 6. As is shown in FIG. 6, a subtitle segment (for example, the segment 154) may be defined using the same NPT values as its corresponding audio segment (for example, the segment 152), and may also contain texts encompassing one or more dialogs (i.e., human speech content) occurring between some of those NPT values. In the segment 154, a first dialog occurs between NPT values 502 and 504, whereas a second dialog occurs between the NPT values 608 and 611 as shown at the bottom of FIG. 6. In one embodiment, the VPS 77 may store the segment-specific subtitle text along with segment-specific NPT values in the database 72. In a future search of the database, the subtitle segment 154 (and, hence, the corresponding video content) may be identified when matching text array data are received (for example, from the user device 53). The VPS 77 may also store additional content-specific information with each audio segment and video segment (as represented through its subtitle segment) stored in the database 72. Such information may include, for example, the title of the related audio-visual content (here, the title of the Discovery Channel episode), the general nature of the content (for example, a reality show, a horror movie, a documentary film, a science fiction program, a comedy show, etc.), the channel on which the content was aired, and so on.

Thus, in the manner illustrated in the exemplary FIG. 6, the VPS 77 may process live broadcast content and “fill” the database 72 with relevant information to facilitate subsequent searching of the database 72 by the remote server 62 to identify an audio-visual portion (through its audio and subtitle segments stored in the database 72) that most closely matches the audio-video content currently being played on the video playback system 56-57 (FIG. 3). In this manner, the remote server 62 can provide the estimated location information in response to a look-up request by the user device 53 (FIG. 3).

FIG. 7 provides an exemplary illustration 157 showing how a VOD (or other non-live or pre-stored) content may be processed according to one embodiment of the present disclosure to generate respective audio and video segments therefrom. Except for the difference in the type of the audio-visual content (live vs. pre-stored), the process illustrated in FIG. 7 is substantially similar to that discussed with reference to FIG. 6. Hence, based on the discussion of FIG. 6, only a very brief discussion of FIG. 7 is provided herein to avoid undue repetition. The VOD content being processed in FIG. 7 is a complete movie titled “Avengers.” The VPS 77 may receive (for example, from the VOD database 83 in FIG. 3) a movie stream 159 containing a video stream 160, a corresponding audio stream 161 (containing the background audio or music), and a subtitles stream 162 representing human speech content (for example, as Line 21 information mentioned earlier) of the video stream 160. All of these data streams may be contained in any of the known container formats—for example, the MP4 format or the MPEG TS format. If the movie content is stored in an encoded and/or compressed format, in one embodiment, the VPS 77 may first decode or decompress the content (as needed). A starting NPT value 164 (NPT=0) and an ending NPT value 165 (NPT=8643) for the movie stream 159 are also shown in FIG. 7. Assuming a one second duration between two consecutive NPT values (also referred to as “NPT time stamps or “NPT time ranges”), it is seen that the highest NPT value of 8643 may represent a total of 8644 seconds or approximately 144 minutes of movie content (8644/60=144.07) from start to finish. As in case of FIG. 6, the VPS 77 may first demultiplex or extract audio and subtitles streams from the movie stream 159 as indicated by reference numeral “166.” In the embodiment of FIG. 7, the VPS 77 may generate “n” number of segments (from the extracted streams), each segment having 120 to 240 seconds in length as “measured” using NPT time ranges 167. An exemplary audio segment 169 and its associated subtitle segment 170 are shown in FIG. 7. Each of these segments has a starting NPT value of 3990 and ending NPT value of 4215, implying that each segment is 226 seconds long (4215−3990+1=226).

In case of the audio segment 169, the VPS 77 may also generate an LSH table for the audio segment 169 and then update the database 72 with the LSH and NPT values associated with the audio segment 169. In one embodiment, the VPS 77 may store the content of the video stream 160 in the database 72 by using the video stream's representational equivalent—i.e., all of the subtitle segments (like the segment 170) generated during the processing illustrated in FIG. 7. As before, a subtitle segment (for example, the segment 170) may be defined using the same NPT values as its corresponding audio segment (for example, the segment 169), and may also contain texts encompassing one or more dialogs (i.e., human speech content) occurring between some of those NPT values. In the segment 170, a first dialog occurs between NPT values 3996 and 4002, whereas a second dialog occurs between the NPT values 4015 and 4018 as shown at the bottom of FIG. 7. In one embodiment, the VPS 77 may store the segment-specific subtitle text along with segment-specific NPT values in the database 72. The VPS 77 may also store additional content-specific information with each audio segment and video segment (as represented through its subtitle segment) stored in the database 72. Such information may include, for example, the title of the related audio-visual content (here, the title of the movie “Avengers”) and/or the general nature of the content (for example, a movie, a documentary film, a science fiction program, a comedy show, and the like).

Thus, in the manner illustrated in the exemplary FIG. 7, the VPS 77 may process VOD or any other pre-stored audio-visual content (for example, a video game, a television show, etc.) and “fill” the database 72 with relevant information to facilitate subsequent searching of the database 72 by the remote server 62 to identify an audio-visual portion (through its audio and subtitle segments stored in the database 72) that most closely matches the audio-video content currently being played on the video playback system 56-57 (FIG. 3). In this manner, the remote server 62 can provide the estimated location information in response to a look-up request by the user device 53 (FIG. 3).

In one embodiment, a service provider (whether a cable network operator, satellite service provider, an online streaming video service, a mobile phone service provider, or any other entity) may offer a subscription-based, non-subscription based, or free service to deliver targeted content on a user device based on remote estimation of what part of an audio-visual content is currently being played on a video playback system that is in physical proximity to the user device. Such service provider may supply a second screen app that may be pre-stored on the user's user device or the user may download from the service provider's website. The service provider may also have access to a remote server (for example, the server 12 or 62) for backend support of look-up requests sent by the second screen app. In this manner, various functionalities discussed in the present disclosure may be offered as a commercial (or non-commercial) service.

The foregoing describes a system and method where a second screen app “listens” to audio clues from a video playback unit using a microphone of a portable user device (which hosts the second screen app). The audio clues may include background music or audio as well as non-audio human speech content occurring in the audio-visual content that is currently being played on the playback unit. The background audio portion may be converted into respective audio fragments in the form of Locality Sensitive Hashtag (LSH) values. The human speech content may be converted into an array of text data using speech-to-text conversion. The user device or a remote server may perform such conversions. The LSH values may be used by the server to find a ballpark estimate of where in the audio-visual content the captured background audio is from. This ballpark estimate may identify a specific video segment. With this ballpark estimate as the starting point, the server matches dialog text array with pre-stored subtitle information (associated with the identified video segment) to provide a more accurate estimate of the current play-through location within that video segment. Additional accuracy may be provided by the user device through a timer-based correction of various time delays encountered in the server-based processing of audio clues. Multiple video identification techniques—i.e., LSH-based search combined with subtitle search—are thus combined to provide fast and accurate estimates of an audio-visual program's current play-through location.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

The invention claimed is:

1. A method of remotely estimating what part of an audio-visual content is currently being played on a video playback system, wherein the estimation is initiated by a user device in the vicinity of the video playback system, and wherein the user device includes a microphone and is configured to support provisioning of a service to a user thereof based on an estimated play-through location of the audio-visual content, the method comprising performing the following steps by a remote server in communication with the user device via a communication network:
receiving audio data from the user device via the communication network, wherein the audio data electronically represents background audio as well as human speech content occurring in the audio-visual content currently being played, wherein the audio data includes
a plurality of Locality Sensitive Hashtag (LSH) values associated with the background audio in the audio-visual content currently being played,
an array of text data generated from speech-to-text conversion of the human speech content in the audio-visual content currently being played, and
wherein the step of analyzing the received audio data includes analyzing the received LSH values and the text array further comprising
analyzing the received LSH values to identify an associated audio clip,
estimating a video segment in the audio-visual content to which the identified audio clip belongs, and
using the video segment as a starting point, further analyzing the text array to identify the estimated location within the video segment;
analyzing the received audio data to generate information about the estimated play-through location indicating what part of the audio-visual content is currently being played on the video playback system; and
sending the estimated play-through location information to the user device via the communication network.

2. (canceled)

3. The method of claim 1, further comprising intimating the user device of failure to generate the estimated location information when the analysis of the received LSH values fails to identify an audio clip associated with the LSH values.

4. (canceled)

5. The method of claim 1, wherein the step of analyzing the received LSH values to identify an associated audio clip comprises:
accessing a database that contains information about known audio clips and their corresponding LSH values; and
searching the database using the received LSH values to identify the associated audio clip.

6. The method of claim 5, wherein the database further contains information about video data corresponding to known audio clips, wherein the step of estimating the video segment comprises:
searching the database using information about the identified audio clip to obtain an estimation of the video segment associated with the identified audio clip.

7. The method of claim 1, wherein the step of further analyzing the text array comprises:
retrieving subtitle information for the video segment from a database, wherein the database contains information about known video segments and their corresponding subtitles;
comparing the retrieved subtitle information with the text array to find a matching text therebetween; and
identifying the estimated location as that location within the video segment which corresponds to the matching text.

8. The method of claim 7, wherein the step of retrieving subtitle information comprises:
searching the database using information about the estimated video segment to retrieve the subtitle information.

9. The method of claim 7, further comprising identifying the estimated location as the beginning of the video segment when the comparison between the retrieved subtitle information and the text array fails find the matching text.

10. The method of claim 1, wherein the estimated play-through location information comprises at least one of the following:
title of the audio-visual content currently being played;
identification of an entire video segment containing the background audio;
a first Normal Play Time (NPT) value for the video segment;
identification of a subtitle text within the video segment that matches the human speech content; and
a second NPT value associated with the subtitle text within the video segment.

11. The method of claim 1, wherein the communication network includes an Internet Protocol (IP) network.

12. The method of claim 1, wherein the step of analyzing the received audio data includes:
generating the following from the audio data:
a plurality of Locality Sensitive Hashtag (LSH) values associated with the background audio in the audio-visual content currently being played, and
an array of text data representing the human speech content in the audio-visual content currently being played; and
analyzing the generated LSH values and the text array.

13.-18. (canceled)

19. A system for remotely estimating what part of an audio-visual content is currently being played on a video playback device, the system comprising:
a user device; and
a remote server in communication with the user device via a communication network;
wherein the user device is operable in the vicinity of the video playback device and is configured to initiate the remote estimation to support provisioning of a service to a user of the user device based on the estimated play-through location of the audio-visual content, wherein the user device includes a microphone and is further configured to send audio data to the remote server via the communication network, wherein the audio data electronically represents background audio as well as human speech content occurring in the audio-visual content currently being played; and
wherein the remote server is configured to perform the following:
receive the audio data from the user device,
analyze the received audio data to generate information about an estimated position indicating what part of the audio-visual content is currently being played on the video playback device, wherein the remote server is configured to analyze the received audio data by:
generating the following from the received audio data:
a plurality of Locality Sensitive Hashtag (LSH) values associated with the background audio in the audio-visual content currently being played, and
an array of text data obtained by performing speech-to-text conversion of the human speech content in the audio-visual content currently being played; and
analyzing the generated LSH values and the text array to generate the estimated position information, wherein the remote server is configured to analyze the received audio data by analyzing the received LSH values and the text array, further comprising
analyzing the received LSH values to identify an associated audio clip,
estimating a video segment as a starting point, further analyzing the text array to identify the estimated location within the video segment; and
send the estimated position information to the user device via the communication network.

20.-22. (canceled)
